(19) United States
(12) Patent Application Publication
(10) Pub. No.: US 2026/0291235 A1
(43) Pub. Date: Sep. 24, 2026

(54) LOAD CONTROL

(71) Applicant: Landis+Gyr Technology, Inc., Alpharetta, GA (US)

(72) Inventors: Matt KARLGAARD, Pequot Lakes, MN (US); David DECKER, Alpharetta, GA (US); Adrian SHARMAN, Alpharetta, GA (US); Shishir SHEKHAR, Alpharetta, GA (US); Nicholas P. MERRICKS, Alpharetta, GA (US); Amith KOTA, Alpharetta, GA (US); Dan ROBERTSON, Alpharetta, GA (US); Antonio HILDALGO, Alpharetta, GA (US)

(21) Appl. No.: 19/474,353

(22) PCT Filed: Apr. 12, 2024
(86) PCT No.: PCT/US2024/024223

§ 371 Date: Oct. 10, 2025

Related U.S. Application Data
(60) Provisional application No. 63/495,790, filed on Apr. 13, 2023.

(51) Int. Cl. H02J 3/14; H02J 3/38; H02J 13/12; H02J 13/14; H02J 13/34; H02J 101/24

(52) U.S. Cl. CPC H02J 3/14; H02J 3/38; H02J 13/12; H02J 13/14; H02J 13/34; H02J 2101/24

(57) ABSTRACT

A system for providing load control. The system comprises an electric meter connected to a power network, one or more end devices connected to the electric meter, and a controller. Each end device comprises a load control switch, a controller, and a communication interface. The load control switch is configured to control the load supplied to or received from the end device by the power network. The controller is configured to control the load control switch responsive to receiving a first control signal via the communication interface.

### TECHNICAL FIELD

The invention relates to a load control system with end devices, and corresponding methods.

### BACKGROUND

Load control systems are a rapidly evolving area of technology that is becoming increasingly important in the context of modern energy management. These systems are designed to manage the power supplied or received by one or more end devices, with the goal of managing a power network, optimizing energy usage and reducing costs. Typically, dedicated load control switch hardware is provided between end devices and any electric meter they are connected to. This dedicated load control switch which can be switched on or off to connect or disconnect the respective end devices to and from the power network.

Despite the significant progress that has been made in the field of load control systems, there are still many challenges and shortcomings. For example, many existing implementations are limited in their ability to accurately predict, respond, and control load at a granular level in response to changes in energy demand, which can lead to inefficiencies and increased costs.

Overall, improvements are desired to overcome these and other shortcomings of existing implementations, and to continue advancing the field of load control systems with end devices.

### SUMMARY

In general terms, the present disclosure is directed to a system for controlling the power supplied or received by one or more end devices connected to an electric meter. This system includes a load control switch, which is controlled by a controller that receives a control signal via a communication interface. Advantageously, this disclosure solves the problem of inefficient and limited load management at the end device level by utilizing the electric meter, and/or an individual end device, for local communication and control of the end devices, eliminating the need for separate load control switch hardware and providing more granular control options. For example, it is envisaged that the load control functionality of the present disclosure is a software-defined load control switch functionality, whereby the end devices are smart devices capable of having software programmes installed thereon which can accordingly facilitate end devices' existing load control capabilities for load control of the wider power network more generally, without needing to install separate, dedicated load control switches for this purpose. It is envisaged that the software-defined load control switch functionality may be implemented fully in the electric meter, fully in one or more end devices, fully in an external enterprise platform at a head-end of the system, or distributed across one or more of these platforms. For example, the system of the present disclosure facilitates using electric meters as pass-through devices for forwarding control commands from a power grid provider from e.g. a head-end to an end device without additional expensive communication setups. Additionally or alternatively, the present disclosure facilitates orchestrating load control actions of end devices based on other inputs, for example user comfort settings, energy prices, carbon content of energy parameters, predetermined utility rules (e.g. received from a power network provider or local authority), time of use (TOU) rate plans, weather data, local load data, power generation forecast data, and others. In this way, load can be controlled in a way that takes into more parameters, variables and factors than just the instructions of a control command. For example, these inputs may form part of inputs to a load management algorithm used to manage the power network generally, and thus provide improved modelling as there are more input data points. Additionally or alternatively, one or more meters may themselves orchestrate action within a local network of electric meters and end devices of multiple premises. These may be grouped in one or more ways, for example based on distribution network layout or some other logical grouping. The meters in this setup may accordingly communicate with other meters through an advanced metering infrastructure (AMI) communication network.

According to an aspect of the invention, there is provided a system for providing load control. The system comprises an electric meter connected to a power network and one or more end devices connected to the electric meter. Each end device comprises a load control switch, a controller, and a communication interface. The load control switch is configured to control the load supplied to or received from the end device by the power network. The controller is configured to control the load control switch. The controller is further configured to control the load control switch responsive to receiving a first control signal via the communication interface.

Optionally, the electric meter is configured to send the first control signal to the end device.

Optionally, the electric meter is configured to send the first control signal to the end device responsive to receiving a second control signal over a communications network. Optionally, at least one end device is configured to send the first control signal to the other end devices.

Optionally, the at least one end device is configured to send the first control signal to the end device responsive to receiving a second control signal over a communications network.

Optionally, the second control signal comprises a control signal transmitted by a utility provider of the power network.

Optionally, the second control signal comprises a control signal transmitted by at least one end device.

Optionally, the system controls the load supplied to or received from the end device by the power network by turning the end device on or off, or setting the device to a predetermined load value. For example, the load control switch may change the load value to a predetermined level between a device operation level of 0% (i.e. such that the device is in an off state) and 100% (i.e. a minimum load value to provide maximum device functionality). In a non-limiting example, the predetermined value may be e.g., 0%, 10%, 20%, . . . 100%, etc. Optionally, the predetermined value may be any value between 0% and 100%.

Optionally, at least one end device is further configured to (i) collect data associated with the end device, and (ii) send the collected data via the communications interface.

Optionally, the collected data includes usage data of the end device, the device type of the end device, maximum rated load or sourcing capability of the end device, a present load state of the end device, and end device user comfort settings.

Optionally, the electric meter is configured to receive the collected data, and the controlling of the load control switch is based on the received collected data by sending of the first control signal.

Optionally, the plurality of end devices comprises one or more of an electric vehicle charger, an HVAC system, a hot water heater, an air conditioner, a thermostat, a heat pump, a pool pump, a refrigerator, a dryer, a solar inverter, and a battery system.

Optionally, the load control switch of the end device is integrated with the end device.

Optionally, said first control signal comprises control instructions and wherein the system comprises one or more processors configured to determine contents of said control instructions, the one or more processors being provided at one or more of the end devices, at the electric meter, and/or at a server of a provider of the power network.

Optionally, the determination is based on one or more of: end device user comfort settings, an energy price, a carbon content of energy, one or more rules determined by a provider of the power network

According to an aspect of the invention, there is provided a method of controlling an end device in a power network having an electric meter and a plurality of end devices connected to the electric meter. The method comprises the steps of: receiving, by the electric meter, a load management control signal from a utility provider of the power network; sending, by the electric meter, an end device management control signal to one or more of the end devices, the end device management control signal being based on the load management control signal; receiving, by the one or more end devices, the end device management control signal; and controlling a load control switch of the one or more end devices based on the received end device management control signal.

Optionally, the method includes collecting data associated with the plurality of end devices by one or more of the end devices, and sending the collected data to the electric meter.

Optionally, the electric meter sends the collected data to the utility provider of the power network.

Optionally, the electric meter receives a further load management control signal from the utility provider, the further load management control signal being based on the received collected data.

Optionally, the plurality of end devices includes one or more of an electric vehicle charger, an HVAC system, a hot water heater, an air conditioner, a thermostat, a heat pump, a pool pump, a refrigerator, a dryer, a solar inverter, and a battery system.

According to an aspect of the invention, there is provided a method of controlling an end device in a power network having a plurality of end devices. The method comprises the steps of: sending, by one of the end devices, an end device management control signal to one or more of the other end devices; receiving, by the one or more other end devices, the end device management control signal; and controlling a load control switch of the end devices based on the received end device management control signal.

Optionally, said sending of the end device management control signal of one or more of the other end devices comprises sending the end device management control signal via an electric meter.

Optionally, the plurality of end devices comprises one or more of an electric vehicle charger, an HVAC system, a hot water heater, an air conditioner, a thermostat, a heat pump, a pool pump, a refrigerator, a dryer, a solar inverter, and a battery system.

### BRIEF DESCRIPTION OF THE DRAWINGS

These are and other aspects will now be described in relation to the Figures in which:

FIG. 1 illustratively shows a system for providing load control according to the present disclosure.

FIG. 2 illustratively shows a flowchart for performing a method according to the present disclosure.

FIG. 3 illustratively shows a flowchart for performing a method according to the present disclosure.

FIG. 4 illustratively shows a flowchart of a method according to the present disclosure.

### DETAILED DESCRIPTION

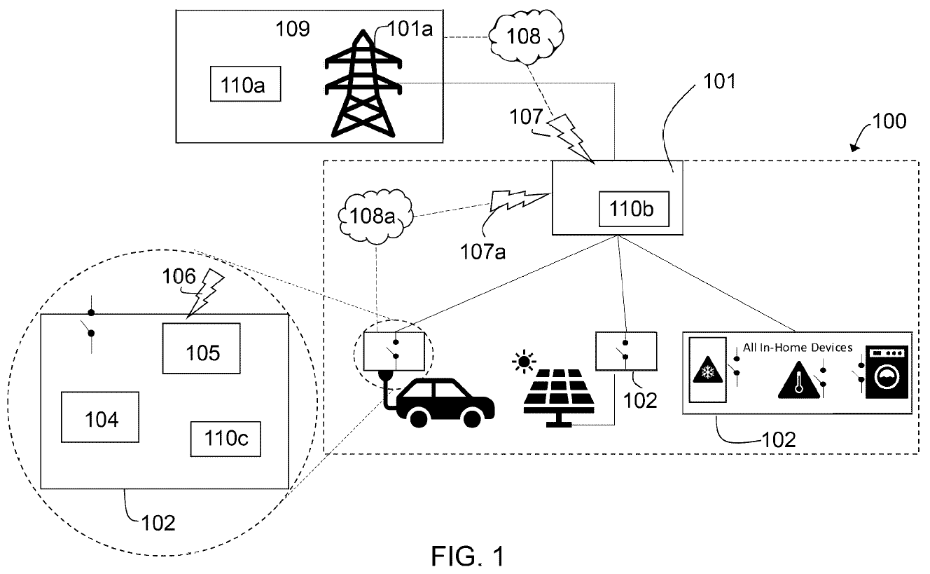

FIG. 1 illustratively shows a system 100 for providing load control according to the present disclosure. The system 100 comprises an electric meter 101 connected to a power network 101a, and one or more end devices 102 connected to the electric meter 101. Each end device 102 includes a load control switch 103 configured to control the load supplied to or received from the end device 102 by the power network, a controller 104 configured to control the load control switch 103, and a communication interface 105. The controller 104 is configured to control the load control switch 103 responsive to receiving a first control signal 106 via the communication interface 105.

Advantageously, the system 100 allows for more granular control of the load supplied to or received from the end devices 102, as opposed to traditional load control switches that only provide on and off states. This is particularly beneficial for devices that are not designed to have power removed completely. The electric meter 101 connects to various in-home and out of home devices, such as electric vehicles (EVs), heating, ventilation, and air conditioning (HVAC) systems, hot water heaters, air conditioners, thermostats, heat pumps, pool pumps, refrigerators and freezers, washers, dryers, solar inverters, battery storage, and other large load or generation devices (i.e. Distributed Energy Resources or DERs) with a communication channel. The communication connection can utilize any wired or wireless communication method, including mesh networks, WiFi, ZigBee, and others.

In some embodiments the electric meter 101 is configured to send the first control signal 106 to the end device 102. For example, this may be responsive to a determination made by orchestration, coordination and/or control command functionality running fully in the electric meter, whereby load control requirements are determined by a controller in the electric meter 101 itself.

Additionally or alternatively, in some embodiments the electric meter 101 is configured to send the first control signal 106 to the end device 102 responsive to receiving a second control signal 107, 107a over a communications network 108, 108a. In some embodiments, this second control signal 107 may be generated and transmitted by, for example, orchestration, coordination and/or control command functionality running externally to the meter, for example on an enterprise platform (such as that run by a utility provider 109 at a head-end) and transmitted through a communication network 108. Additionally or alternatively, in some embodiments this second control signal 107a may be generated and transmitted by orchestration, coordination and/or control command functionality running, for example on one or more of the end devices 102 and transmitted through to the electric meter 101 over an on-premises, or other local, network 108a.

It will be appreciated that the software-defined load control switch of the present disclosure relies on end devices having some degree of smart functionality. That is, functionality where they may receive, process, and act on control commands. In the event that one or more end devices do not have smart functionality, these may be still be controlled using known methods, for example by controlling any dedicated, separate load control switch hardware, for example at the meter port at which the end device is connected, or at a dedicated load control switch in the circuit to which the end device is connected.

In the above examples, the first and second control signals may be sent to and from the electric meter and/or end devices using proprietary and/or open source communication protocols. For example, any communications between a utility head-end and a meter may be transmitted over cellular networks, mesh networks (including WiSun), PLC networks and others. For example, any communications between the electric meter and any end devices may be transmitted over mesh networks (including WiSun), WiFi networks, ZigBee networks, Bluetooth networks, thread networks and others. More generally, it is envisaged that exemplary communications protocols include IEEE 2030.5, OpenADR, Modbus, Matter and others. These examples are intended to be illustrative only and are not limiting.

Advantageously, this configuration eliminates the need for separate, dedicated load control switch hardware to be installed between the power network and the end device 102. Instead, the internal switch control of each end device 102 is used as a load control switch, which can be controlled over a communication network. This reduces the security implications and potential additional fees associated with direct cloud connectivity for remote control, as might be provided by manufacturers of end devices. Effectively, control communications are piggybacking on the utility provider's communications network. The end devices 102 may use various communication interfaces, such as 2030.5, OpenADR, Matter, ModBus, and others.

In some embodiments 102 at least one end device 102 is configured to send the first control signal 106 to the other end devices 102. In some embodiments the at least one end device 102 is configured to send the first control signal 106 to the end device 102 responsive to receiving a second control signal 107 over a communications network 108, for example run and managed by a utility provider 109.

Advantageously, this arrangement allows for a greater degree of flexibility in managing power networks where the end device hardware in the network is not uniform or identical in its capabilities. For example, one end device could have software installed on it that allows it to receive utility provider load control messages directly and then send its own control messages to the other end devices.

In some embodiments the second control signal 107 comprises a control signal transmitted by a utility provider 109 of the power network. In some embodiments the system 100 comprises controlling the load supplied to or received from the end device 102 by the power network, which may include turning the end device 102 on or off, or setting the device to a predetermined load value.

Advantageously, this allows users to set their comfort settings for each end device 102, including when they will need to use the device and for how long, so that any control signals can be based at least in part on this information to not inconvenience the user when control signals are sent. Utilities can also enforce times when certain devices can be turned off based on consumer agreements, local legislation, etc. The meter 101 will keep track of various features of the end devices it controls, such as end device type, approximate maximum load or sourcing capability (in kW), current state, and user comfort settings.

In some embodiments 102 at least one end device 102 is further configured to collect data associated with the end device 102 and send the collected data via the communications interface 105.

Advantageously, if there is any metrology data available from the end device 102, it will be sent back to the meter 101 to be used to help determine the load presented by that device. If there is any metrology data available, the meter 101 will utilize comparative measurement just before and after turning the device on or off to determine approximate load. This information will likely be stored in a central system but some or all of it could be stored locally in the meter 101, with or without redundancy at the central system. In general terms, it is envisaged that this information may be used to determine an overall controllable load or distributed generation, and/or as an input to one or more load/generation prediction algorithms for improved load management of the power network. For example, the system may control the level of end device to a specific level i.e. 60% and/or be utilised to provide an on/off control for the end device. In one example, the end device may be an end device that provides power generation capabilities or forms part of a system that provides power generation, such as a solar inverter. In such cases, the system may be configured to control the generation of the power generating device (e.g. a solar inverter) to the specified level, for example based on the selected or predetermined load value. As such and generally speaking, embodiments may be configurable to set the generation level of a generating power device to a set level from 0% to 100% (e.g., 0%, 10%, 20%, . . . 100%, or any value between 0% and 100%, including non-integer values, etc.), where 0% represents an off state and 100% represents a maximum power generation of the end device.

In some embodiments, the collected data comprises one or more of usage data of the end device 102, the device type of the end device 102, maximum rated load or sourcing capability of the end device 102, and a present load state 116 of the end device 102. Advantageously, collecting and analyzing this data allows the system 100 to better understand the characteristics and capabilities of each end device 102, enabling more efficient and tailored load management. For example, by knowing the maximum rated load or sourcing capability of an end device 102, the system 100 can prevent overloading the power network and ensure optimal power distribution among the connected devices. Additionally, the usage data and present load state 116 can be used to determine the most appropriate load set points for each end device 102, taking into account user comfort settings and other factors.

In some embodiments, the electric meter 101 is configured to receive the collected data, and the controlling of the load control switch 103 by sending of the first control signal 106 is based on the received collected data. Advantageously, this allows the electric meter 101 to make informed decisions about load control based on the actual characteristics and usage patterns of the end devices 102. This can lead to more efficient power management and better alignment with user preferences, as well as compliance with utility provider requirements and local regulations.

In some embodiments, the plurality of end devices 102 comprises one or more of an electric vehicle charger, an HVAC system, a hot water heater, an air conditioner, a thermostat, a heat pump, a pool pump, a refrigerator, a dryer, a solar inverter, and a battery system. Advantageously, this wide range of end devices 102 demonstrates the versatility and adaptability of the system 100, as it can accommodate various types of devices with different power requirements and communication interfaces. This allows for a more comprehensive and flexible load management solution that can be tailored to the specific needs of each household or power network. Where an electric vehicle charger is present, it is envisaged that communication to and control of the electric vehicle charger may be performed using Open Charge Point Protocol (OCPP). However, it will be appreciated that any other suitable protocol may also be used.

In some embodiments, the load control switch 103 of the end device 102 is integrated 128 with the end device 102. Advantageously, this integration eliminates the need for separate, dedicated load control switch hardware to be installed between the power network and the end device 102, reducing installation costs and complexity. Furthermore, the integrated load control switch 103 allows for more granular control of the load supplied to or received from the end device 102, as opposed to traditional load control switches that only provide on and off states. This is particularly beneficial for devices that are not designed to have power removed completely, as it enables smoother transitions between different load set points.

In some embodiments, the first control signal comprises instructions and the system comprises one or more processors 110a, 110b, 110c configured to determine the contents of the control instructions (i.e. commands to turn a load control switch on, off or to set it to a predetermined load values). The one or more processors 110a, 110b, 110c may be provided at the one or more end devices 102, at the electric meter 101, and/or at server of the provider 109 of the power network. In this way, the orchestration, coordination, and control can be provided fully in the meter, fully in the end device, fully in an enterprise platform at the head-end (i.e. controlled by the utility provider 109), or distributed between two or more of these places. In some embodiments, the determination of the contents of the control instructions may be based on user comfort settings (e.g. a user specified charge percentage of an electric vehicle the user does not want to drop below, and so on), energy price, carbon content of energy, utility rules (e.g. sent to it by the overhead system), local authority rules, and so on.

This facilitates the following exemplary implementations: (i) the electric meter acts as a pass-through device with control coming from above from the utility provider thereby providing a convenient way to make a connection from a head-end to an end device without additional, expensive communication setups, (ii) one meter orchestrates action within a local network of meters and end devices of multiple premises grouped based on distribution network layout or some other logical grouping whereby the meter may communicate with the other meters with an AMI communication network. Other implementations are also envisaged.

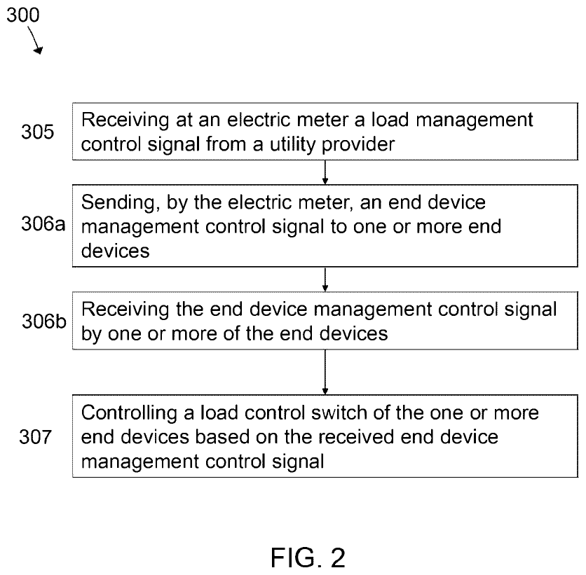

FIG. 2 illustratively shows a flowchart 300 for performing a method according to the present disclosure. The method includes four steps: receiving 305 a load management control signal from a utility provider, sending 306a an end device management control signal to one or more end devices, receiving 306b the end device management control signal by the one or more end devices, and controlling 307 a load control switch of the one or more end devices based on the received 306b end device management control signal. Advantageously, this method provides a clear and efficient process for managing the load of various end devices 102 in a power network, ensuring optimal power distribution and compliance with utility provider requirements.

In some embodiments, the method 300 comprises collecting data associated with the plurality of end devices by one or more of the end devices and sending the collected data to the electric meter. Advantageously, this allows the electric meter to receive real-time information about the end devices, enabling more accurate and responsive load management decisions. This can lead to improved energy efficiency and better alignment with user preferences and utility provider requirements.

In some embodiments, the method 300 comprises sending the collected data to the utility provider of the power network. Advantageously, this enables the utility provider to have direct access to the collected data, allowing them to make more informed decisions about load management and power distribution. This can result in more efficient power networks and better compliance with local regulations and consumer agreements.

In some embodiments the method 300 comprises receiving, by the electric meter, a further load management control signal from the utility provider, the further load management control signal being based on the received collected data.

Advantageously, this embodiment allows the utility provider to make more informed decisions regarding load management based on the collected data from the end devices. This data may include information about the end device type, approximate maximum load or sourcing capability (in kW), current state, and user comfort settings. By utilizing this data, the utility provider can optimize load management strategies, taking into account user preferences and device capabilities, ultimately leading to more efficient energy usage and potential cost savings for both the utility provider and the end users.

In some embodiments the plurality of end devices comprises one or more of an electric vehicle charger, an HVAC system, a hot water heater, an air conditioner, a thermostat, a heat pump, a pool pump, a refrigerator, a dryer, a solar inverter, and a battery system.

Advantageously, the ability to communicate with and control this wide range of end devices allows for a more comprehensive and versatile load management system. By incorporating various types of devices with different power requirements and usage patterns, the system can better adapt to the diverse energy needs of a household or building. This flexibility enables the system to manage power networks more effectively, even when the end device hardware in the network is not uniform or identical in its capabilities.

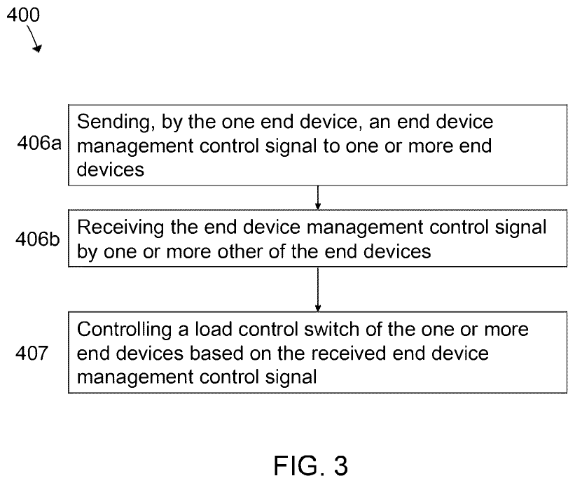

FIG. 3 illustratively shows a flowchart 400 for performing a method according to the present disclosure. The method includes four steps: sending 406a an end device management control signal by one of the end devise to one or more other end devices, receiving 406b at the one or more other end devices the end device management control signal, and controlling 407 a load control switch of the end devices based on the received end device management control signal.

The end device management control signal may be sent to the one or more other end devices through an electric meter, whereby the electric meter acts as a pass-through device to facilitate communications between the end devices. More particularly, the end device management control signal may be sent responsive to a control command from a processor on the end device running orchestration, coordination and/or control command functionality. Additionally or alternatively, the end device management control signal may be sent responsive to receiving a load management control signal from a utility provider, or from the electric meter, or from one or more of the other end devices running orchestration, coordination and/or control command functionality.

Advantageously, this method provides a clear and efficient process for managing load control in a power network where the orchestration, coordination and/or control command functionality is being run fully in the electric meter, fully in the end device, fully externally by a utility provider 109 (e.g. enterprise platform at the head-end of a power network), or distributed between two or more of these places. The system can effectively control the load supplied to or received from the end devices in a way that allows for more granular control of the load, enabling devices to operate at various load set points (e.g., 0%, 10%, 20%, . . . 100%, etc.) rather than just on and off states, which is particularly beneficial for devices that are not designed to have power removed completely. It will be understood that the set point may be any value between an off state (i.e. 0%) and a minimum load value (i.e. 100% device operation).

The plurality of end devices comprises electric vehicle charger, HVAC system, hot water heater, air conditioner, thermostat, heat pump, pool pump, refrigerator, dryer, solar inverter, and battery system.

Advantageously, the inclusion of this diverse set of end devices in the system allows for more comprehensive load management and control. By connecting various in-home devices with different power requirements and usage patterns, the system can better adapt to the diverse energy needs of a household or building. This flexibility enables the system to manage power networks more effectively, even when the end device hardware in the network is not uniform or identical in its capabilities. Furthermore, the use of local communication methods, such as mesh networks, WiFi, ZigBee, and others, enables secure and efficient communication between the electric meter and the end devices, eliminating the need for separate, dedicated load control switch hardware and reducing potential security risks and additional fees associated with direct cloud connectivity for remote control.

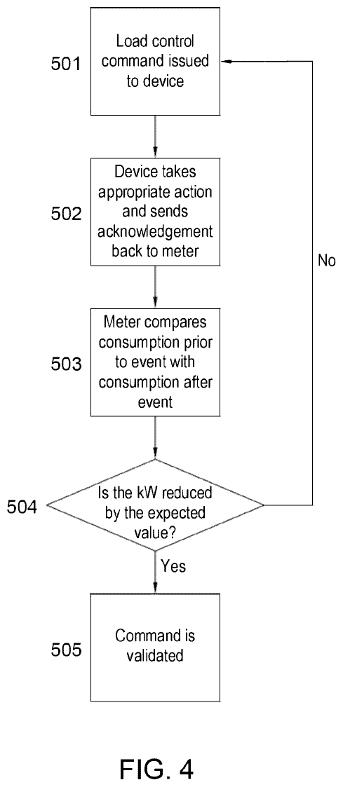

FIG. 4 illustratively shows a method according to the present disclosure, illustrating an example implementation of a meter validating whether or not a load command has been successful in controlling the load of an end device. In a first step, a load control command is issue 501 by a meter to an end device. The end device receives the issued command, takes any applicable actions 502 and sends an acknowledgement back to the meter. The meter receives the acknowledgement and compares 503 a measured consumption of the end device before the load control command was issued to the consumption of the end device after the load control command was issued. If the measured consumption is reduced or increased in kW by the expected amount then the load control command is validated 505 and considered successful. If the measured consumption is not reduced or increased by the expected amount then the load control command is not validated, and the meter re-issues the load control command.

It will be understood that the term “sourcing capability” as used herein may refer to the ability of a system or component to provide, manage, or regulate the power supply from various sources to one or more end devices connected to an electric meter, such as renewable energy sources, energy storage systems, or utility power grids.

It will be understood that the term “integrated” as used herein may refer to the combination or incorporation of various components, such as hardware, software, or subsystems, within a single system or device to enable seamless and efficient functioning of the overall system, such as the power control system described in the invention.

It will be appreciated by the person of skill in the art that various modifications may be made to the above-described examples without departing from the scope of the invention as defined by the appended claims.

For example, it will be appreciated that the system may facilitate not only the on/off and/or predetermined percentage load set point control of end devices, but also the scheduling of specific load events (e.g. turn on at time T, turn off at time T+1 and so on), islanding of groups of end devices, premises, and/or parts of a power network, and other advanced control capabilities such as optimised smart energy manager functionality which is not currently possible with existing systems.

For example, it will be appreciated that the term end device may refer to both load end devices and generation end devices, and these may also be referred to generally as distributed energy resources.

1. A system for providing load control, the system comprising:
an electric meter connected to a power network;
one or more end devices connected to the electric meter, each end device comprising (i) a load control switch configured to control the load supplied to or received from the end device by the power network, (ii) a controller configured to control the load control switch, and (iii) a communication interface;
wherein the controller is configured to control the load control switch responsive to receiving a first control signal via the communication interface.

2. The system of claim 1, wherein the electric meter is configured to send the first control signal to the end device.

3. The system of claim 2, wherein the electric meter is configured to send the first control signal to the end device responsive to receiving a second control signal over a communications network.

4. The system of claim 1, wherein at least one end device is configured to send the first control signal to the other end devices, wherein the at least one end device is configured to send the first control signal to the end device responsive to receiving a second control signal over a communications network.

5. (canceled)

6. The system of claim 3, wherein the second control signal comprises a control signal transmitted by a utility provider of the power network; or wherein the second control signal comprises a control signal transmitted by at least one end device.

7. (canceled)

8. The system of claim 1, wherein said controlling of the load supplied to or received from the end device by the power network comprises turning the end device on or off, or setting the device to a predetermined load value.

9. The system of claim 8 wherein setting the device to a predetermined load value comprises setting the device to an on state and controlling the load supplied to the predetermined load value, wherein the predetermined load value is greater than a minimum load value that can be supplied to or received from the end device by the power network and less than a maximum load value that can be supplied to or received from the end device by the power network.

10. The system of claim 1, wherein the at least one end device comprises a power generation device, and the predetermined load value is selected based on a desired power generation level of the power generation device, and optionally wherein the predetermined load value is selected such that the power generation level of the power generation device is less than a maximum power generation level of the power generation device.

11. (canceled)

12. The system of claim 10, wherein the power generation level is set to a percentage between 0% and 100% of the maximum power generation level of the power generation device, including non-integer values, and optionally wherein the power generation level is set to 10% to 90% of the maximum power generation level of the power generation device, optionally wherein the power generation level is set to 10%, 20%, 30%, 40%, 50%, 60%, 70%, 80% or 90% of the maximum power generation level of the power generation device.

13. The system of claim 1, wherein at least one end device is further configured to (i) collect data associated with the end device and (ii) send the collected data via the communications interface.

14. The system of claim 13, wherein the collected data comprises one or more of usage data of the end device, the device type of the end device, maximum rated load or sourcing capability of the end device, a present load state of the end device, and end device user comfort settings.

15. The system of claim 14, wherein the electric meter is configured to receive the collected data, and wherein said controlling of the load control switch by sending of the first control signal is based on the received collected data.

16. The system of claim 1, herein the plurality of end devices comprises one or more of an electric vehicle charger, an HVAC system, a hot water heater, an air conditioner, a thermostat, a heat pump, a pool pump, a refrigerator, a dryer, a solar inverter, and a battery system.

17. The system of claim 1, wherein the load control switch of the end device is integrated with the end device.

18. The system of claim 1, wherein said first control signal comprises control instructions and wherein the system comprises one or more processors configured to determine contents of said control instructions, the one or more processors being provided at one or more of the end devices, at the electric meter, and/or at a server of a provider of the power network.

19. The system of claim 18, wherein the determination is based on one or more of: end device user comfort settings, an energy price, a carbon content of energy, one or more rules determined by a provider of the power network.

20. The system of claim 1, wherein the load control switch is a software-defined load control switch configured to provide load control functionality.

21. A method of controlling an end device in a power network having an electric meter and a plurality of end devices connected to the electric meter, the method comprising:
receiving, by the electric meter, a load management control signal from a utility provider of the power network,
sending, by the electric meter, an end device management control signal to one or more of the end devices, the end device management control signal being based on the load management control signal;
receiving, by the one or more end devices, the end device management control signal; and
controlling a load control switch of the one or more end devices based on the received end device management control signal.

22. The method of claim 21, comprising collecting, by one or more of the end devices, data associated with the plurality of end devices and sending the collected data to the electric meter, and sending, by the electric meter, the collected data to the utility provider of the power network.

23. (canceled)

24. A method of controlling an end device in a power network having a plurality of end devices, the method comprising:
sending, by one of the end devices, an end device management control signal to one or more of the other end devices, the end device management control signal;
receiving, by the one or more other end devices, the end device management control signal; and
controlling a load control switch of the end devices based on the received end device management control signal.

25. (canceled)
